(19) United States
(12) Patent Application Publication
(10) Pub. No.: US 2016/0096745 A1
(43) Pub. Date: Apr. 7, 2016

(54) WATER DEGASSING SYSTEM AND METHOD

(71) Applicant: Celgard, LLC, Charlotte, NC (US)

(72) Inventors: Paul A. Peterson, Clover, SC (US); Amitava Sengupta, Charlotte, NC (US); Frederick E. Wiesler, Charlotte, NC (US)

(21) Appl. No.: 14/507,899

(22) Filed: Oct. 7, 2014

(51) Int. Cl. C02F 1/20

(52) U.S. Cl. CPC C02F 1/20; C02F 2103/08

(57) ABSTRACT

A system for degassing water includes a membrane contactor of degassing water, and a membrane module for enriching nitrogen from a source having <98% nitrogen purity coupled to said degassing membrane module. The enriching membrane module may be physically connected to the degassing membrane contactor. A method for degassing water includes the steps of: enriching a nitrogen gas having a purity of <98% to a purity of >99% via a membrane module, feeding the enriched nitrogen gas to a degassing membrane contactor, and degassing the water with the degassing membrane contactor. The water may be seawater, and/or ground water, and/or river water and/or surface water.

### FIELD OF THE INVENTION

The invention is directed to a water degassing system and method using membrane contactors for degassing.

### BACKGROUND OF THE INVENTION

In certain industrial processes, degassed water is desired. The entrained or dissolved gas is typically air, which is a mixture of gasses, nitrogen and oxygen being major components. The entrained or dissolved oxygen may have a detrimental impact on the industrial process, including corrosion of equipment and promotion of the growth of biological organisms. Accordingly, it is desired to remove the oxygen prior to use of the water.

Moreover, in certain industrial processes, the weight and space occupied by the degassing equipment is at a premium. This means that it is best that the degassing equipment occupy as little space (volume and/or area) and weigh as little as possible. Also, the sweep gas used by the degassing equipment, for example—nitrogen used in membrane deoxygenation operations, should be at a high level of purity to be able to achieve the desired very low levels of dissolved oxygen in water. That level of nitrogen purity is not typically available at the degassing site, and therefore may require additional equipment to produce the necessary level of purity. The additional equipment occupies space and add weight and that is not desirable.

For example, in the production of oil and gas from off shore wells, the degassing equipment is placed on the platform. To improve oil and gas production from these off shore wells, some inject water into the well to force the oil and gas out of the well. This injection water is preferably deoxygenated. But, degassing equipment adds weight and consumes precious space on the platform. Also, the typical nitrogen available on the platform has a purity insufficient to effectively remove dissolved oxygen. If there is need to put in additional equipment to generate higher-purity nitrogen that will increase more space and weight to the overall deoxygenation equipment.

Accordingly, there is a need for a degassing/deoxygenation system/method that also incorporates means of generating high purity nitrogen, that meets and overcomes the foregoing, and other, issues.

### SUMMARY OF THE INVENTION

A system for degassing water includes a membrane contactor for degassing water, and a membrane device for generating high-purity nitrogen gas (nitrogen enricher) on-site from a source of typically much lower (<98%) nitrogen purity. The membrane nitrogen enricher may be physically connected to the degassing membrane contactor. A method for degassing water includes the steps of: enriching a nitrogen gas having a purity of <98% to a purity of >99% via a membrane nitrogen enricher, feeding the enriched nitrogen gas to a degassing membrane contactor, and degassing the water with the degassing membrane contactor. The water may be seawater, and/or ground water, and/or river water and/or surface water.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a schematic illustration of an embodiment of the present invention.

FIG. 2 is a flow chart illustration another embodiment of the present invention.

### DESCRIPTION OF THE INVENTION

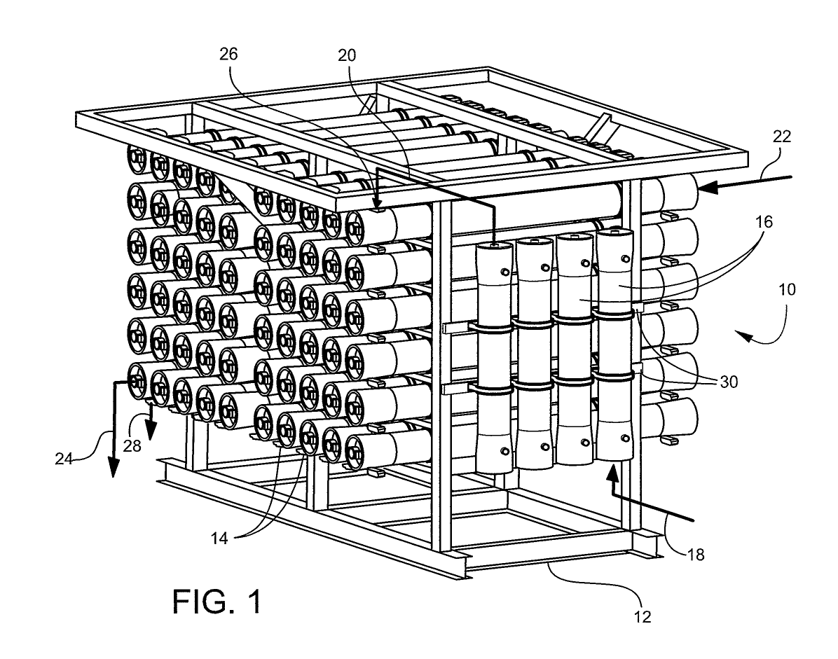

Referring to the drawings wherein like numerals indicate like elements, there is shown in FIG. 1 an embodiment of the present invention. The degassing system 10 generally includes a membrane contactor for degassing water 14 coupled with a nitrogen enrichment membrane device for enriching nitrogen 16.

Water may be any gas entrained water. Water may be seawater, and/or ground water, and/or river water and/or surface water.

A skid (or frame) 12 may support the contactor 14 and device 16. The contactor 16 and device 16 may be physically connected to the skid 12. The use of the skid 12 allows the degassing system to be easily transported to and placed on site.

Degassing membrane contactor 14 may be any conventional membrane contactor for degassing water. There is a least one degassing membrane contactor in the system, and the system may include a plurality of degassing membrane contactors. Such contactors are commercially available under the trade name LIQUI-CEL membrane contactors offered by Polypore, Inc. of Charlotte, N.C., USA. In general, these membrane contactors include a membrane within a housing. The water to be degassed is passed on one side of the membrane, while a vacuum, or a vacuum with sweep gas, is passed on the other side of the membrane. Entrained/dissolved gas in the water is removed from the water by a diffusion process. More specifically, the membranes may be in the form of a bundle of hollow fibers held within a housing. The free end of the fibers may be held in place by tube sheets that form a liquid tight seal with the housing. The water may be passed into the housing and on the outside of the hollow fibers. The lumens of the fibers are evacuated (vacuum) or evacuated with the assistance of a sweep gas. Such membrane contactors are further illustrated in the following: U.S. Pat. No. 5,264,171; U.S. Pat. No. 5,284,584; U.S. Pat. No. 5,695,545; U.S. Pat. No. 5,916,647; U.S. Pat. No. 6,063,277; U.S. Pat. No. 6,207,053; U.S. Pat. No. 6,267,926; U.S. Pat. No. 6,299,820; U.S. Pat. No. 6,402,818; U.S. Pat. No. 6,503,225; U.S. Pat. No. 6,616,841; U.S. Pat. No. 7,264,725; U.S. Pat. No. 7,628,916; U.S. Pat. No. 7,638,049; U.S. Pat. No. 7,641,795; U.S. Pat. No. 7,803,274; U.S. Pat. No. 8,449,659; U.S. Pat. No. 8,506,685; U.S. Pat. No. 8,690,994; U.S. Pat. No. 8,778,055; U.S. Ser. No. 13/697799 filed Sep. 12, 2012; and U.S. Ser. No. 14/465090 filed Aug. 21, 2014, each of which is incorporated herein by reference.

Nitrogen (N₂) enriching membrane device (or module) 16 may be any conventional membrane device for enriching a N₂ gas stream. There is a least one enriching membrane device in the system, and the system may include a plurality of enriching membrane devices. Such membrane devices are commercially available under the trade name GENERON membrane contactors offered by Generon IGS of Houston, Tex., USA. In these contactors, the membrane is tailored to be permselective (ie, the membrane preferentially passes other gasses in the gas stream while preventing the passage of N₂), whereby an enriched N₂ stream may be formed. These nitrogen enrichment membranes can be either hollow fiber or flat sheet form.

The enriching membrane 16 device may be mounted onto the skid 12 or mounted within a cabinet (not shown) that houses the degassing membrane contactor 14 and the enriching membrane 16 (any control systems necessary for the operation of the system 10). As shown in FIG. 1, the enriching membrane device is mounted onto the skid 12 carrying the degassing membrane contactors 14 with the use of a bracket 30. Any conventional bracket 30 may be used.

In operation, system 10 is supplied with N₂ (purity <98% N₂, or <97%, or about 95-98%) from any source to inlet 18. The N₂ is enriched while passing through the enriching membrane device 16 (membrane 16 may be connected in series or in parallel). In one embodiment, the enriched N₂ may have a purity of at least 99%. In another embodiment, the N₂ may have a purity of at least 99.9%. In yet another embodiment, the N₂ may have a purity of at least 99.99%. In still another embodiment, the N₂ may have a purity of at least 99.99+%. The enriched N₂ exits, via outlet 20, and is then fed into the degassing contactor 14 (contactors 14 may be connected in series or in parallel) via inlet 26. In one embodiment, the enriched N₂ requires no compression (increase in pressure) before being sent to be used as sweep gas by the membrane contactors 14 (i.e., the enriched N₂ has sufficient head pressure exiting the N₂ enricher for subsequent use in the membrane contactors 14). Spent N₂ exits the degassing contactors via outlet 28. The gas entrained/dissolved water enters the degassing contactors via inlet 22 and exits via outlet 24. The water exiting the system 10 may have less than or equal to 100 ppb O₂, in one embodiment. In another embodiment, the water exiting the system may have less than or equal to 10 ppb O₂.

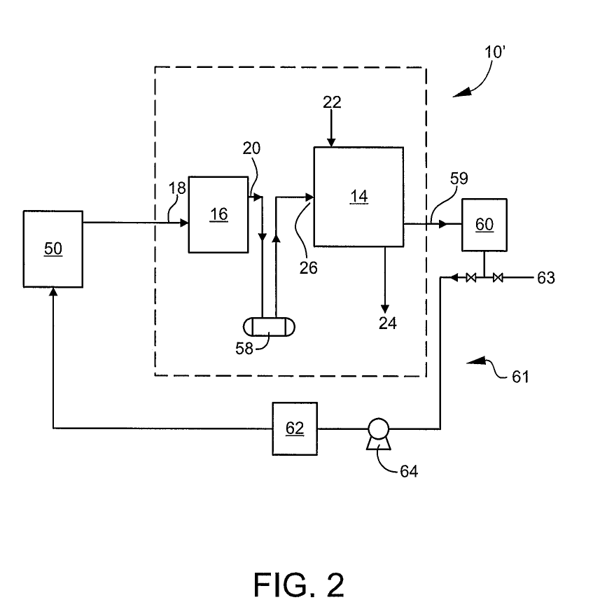

Another embodiment of the system is shown in FIG. 2, system 10′ (within the dotted lines). Nitrogen is supplied from an N₂ generator 50 (purity <98% N₂, or <97%, or about 95-98%). N₂ generator 50 may be any conventional N₂ generator, for example a pressure swing absorber (PSA), compressor system, or a membrane unit. This N₂ is feed to the enriching membrane 16. Enriched N₂ is discharged via outlet 20. In one embodiment, the enriched N₂ may have a purity of at least 99%. In another embodiment, the N₂ may have a purity of at least 99.9%. In yet another embodiment, the N₂ may have a purity of at least 99.99%. In still another embodiment, the N₂ may have a purity of at least 99.99+%. The enriched N₂ may be feed to a surge tank 58 (optional) and then to the inlet 26 of the degassing contactor 14. In one embodiment, the enriched N₂ requires no compression (increase in pressure) before being sent to the be used as sweep gas by the membrane contactors 14 (i.e., the enriched N₂ has sufficient head pressure exiting the N₂ enricher for subsequent use in the membrane contactors 14). The enriched N₂ may be passed through the contactor 14 along with vacuum supplied from vacuum source 60. At the same time water is passed through the degassing contactor 14 from inlet 22 and exits via outlet 24. The water exiting the system 10 may have less than or equal to 100 ppb O₂, in one embodiment. In another embodiment, the water exiting the system may have less than or equal to 10 ppb O₂.

Optionally included is a N₂ recycling system 61. Spent N₂ 59 from the degassing contactor 14 may compressed 64 and dried 62 and may be returned to the N₂ generator 50 or may be exhausted to atmosphere 63.

The present invention may be embodied in other forms without departing from the spirit and the essential attributes thereof, and, accordingly, reference should be made to the appended claims, rather than to the foregoing specification, as indicating the scope of the invention.

We claim:

1. A system for degassing water comprising:
a membrane contactor for degassing water, and a membrane module for enriching nitrogen from a source having <98% nitrogen purity coupled to said degassing membrane contactor.

2. The system of claim 1 wherein said enriching membrane module being physically connected to said degassing membrane contactor.

3. The system of claim 1 wherein said degassing membrane contactor being a plurality of membrane contactors.

4. The system of claim 1 wherein said enriching membrane module being a plurality of enriching membrane modules.

5. The system of claim 1 wherein said enriching membrane module producing nitrogen with a purity of at least 99% nitrogen.

6. The system of claim 1 wherein the water being seawater, and/or ground water, and/or river water and/or surface water.

7. A method for degassing water comprising the steps of:
enriching a nitrogen gas having a purity of <98% to a purity of >99% via a membrane module,
feeding the enriched nitrogen gas to a degassing membrane contactor, and
degassing the water with the degassing membrane contactor.

8. The method of claim 7 wherein the enriching membrane module being physically connected to the degassing membrane contactor.

9. The method of claim 7 wherein said degassing membrane contactor being a plurality of membrane contactors.

10. The method of claim 7 wherein said enriching membrane module being a plurality of enriching membrane modules.

11. The method of claim 7 wherein the water being seawater, and/or ground water, and/or river water and/or surface water.
